(19) United States
(12) Patent Application Publication
(10) Pub. No.: US 2016/0258977 A1
(43) Pub. Date: Sep. 8, 2016

(54) PHYSICAL QUANTITY SENSOR, MANUFACTURING METHOD THEREOF, ELECTRONIC EQUIPMENT, AND MOVABLE BODY

(71) Applicant: Seiko Epson Corporation, Tokyo (JP)

(72) Inventor: Atsuki NARUSE, Shiojiri (JP)

(21) Appl. No.: 15/046,883

(22) Filed: Feb. 18, 2016

(30) Foreign Application Priority Data
Mar. 4, 2015 (JP) 2015-042169

(51) Int. Cl. G01P 15/125

(52) U.S. Cl. CPC G01P 15/125

(57) ABSTRACT

A physical quantity sensor includes: a base; a cover; a function element provided inside a cavity formed by the base and the cover; and a protection film with which a principal surface of the base, a bonding boundary portion between the principal surface of the base and the cover, and the cover are coated continuously, wherein the protection film is an inorganic material film or an organic semiconductor film.

### BACKGROUND

1. Technical Field

The present invention relates to a physical quantity sensor, a manufacturing method thereof, electronic equipment, and a movable body.

2. Related Art

In recent years, physical quantity sensors for detecting physical quantities by using silicon MEMS (Micro Electro Mechanical System) technology have been developed. The use of acceleration sensors for detecting acceleration and gyrosensors for detecting angular velocity, among others, has been spreading rapidly, for example, for hand-held camera shake correction in digital still cameras (DSC), for vehicular navigation, and for motion sensing in game machines.

In such a physical quantity sensor, a function element is housed inside a cavity sealed hermetically.

For example, in JP-A-2013-164285, a physical quantity sensor provided with a function element housed in a cavity formed by a base and a cover is disclosed. In JP-A-2013-164285, anodic bonding is used for bonding a base made of glass and a cover made of silicon to each other.

As a technique for sealing an element such as a vibrator, for example, a technique of bonding a mother board and a cover member to each other with seal by using a sputtering method is disclosed in JP-A-2006-020001. In JP-A-2006-020001, the cover member is covered by resin.

However, in the physical quantity sensor disclosed in JP-A-2013-164285, since the bonding boundary portion between the base and the cover is exposed, during the process of chip dicing, there is a possibility that the cover might come off from the base due to the supply of water (cutting water) to the bonding boundary portion between the base and the cover. Moreover, in the physical quantity sensor disclosed in JP-A-2013-164285, there is a possibility that the cover might come off from the base due to the warping of the base or the cover caused by the difference in coefficient of thermal expansion between the base and the cover when placed in a high-temperature environment or when heat is applied thereto during manufacturing.

In the sealing technique disclosed in JP-A-2006-020001, though the boundary surface between the cover member and the base is covered by the resin, there is a possibility that resin deformation might occur when placed in a high-temperature environment or when heat is applied thereto during manufacturing, resulting in insufficient protection of the boundary surface between the cover member and the base.

### SUMMARY

An advantage of some aspects of the invention is to provide a physical quantity sensor and a manufacturing method thereof that can decrease the possibility that a cover might come off from a base. Another advantage of some aspects of the invention is to provide electronic equipment and a movable body that includes the physical quantity sensor.

The invention can be embodied in the following application examples or modes.

### APPLICATION EXAMPLE 1

A physical quantity sensor according to an application example includes: a base; a cover; a function element provided inside a cavity formed by the base and the cover; and a protection film with which a principal surface of the base, a bonding boundary portion between the principal surface of the base and the cover, and the cover are coated continuously, wherein the protection film is an inorganic material film or an organic semiconductor film.

In this physical quantity sensor, since the principal surface of the base, the bonding boundary portion between the principal surface of the base and the cover, and the cover are coated continuously with the protection film, it is possible to decrease the possibility that the cover might come off from the base.

### APPLICATION EXAMPLE 2

In the physical quantity sensor according to this application example, the base may have a wiring groove that is in communication with the cavity; a wiring line may be formed in the wiring groove; and the wiring groove and the wiring line may be covered by the protection film.

In this physical quantity sensor, since the wiring groove and the wiring line are covered by the protection film, it is possible to seal the wiring groove, thereby sealing the cavity as a space that is hermetically closed.

### APPLICATION EXAMPLE 3

In the physical quantity sensor according to this application example, the base may have a pad; and the wiring line and the pad may be electrically connected to each other.

In this physical quantity sensor, it is possible to decrease the possibility that the cover might come off from the base.

### APPLICATION EXAMPLE 4

A manufacturing method according to an application example is a method for manufacturing a physical quantity sensor that includes a function element provided inside a cavity formed by a base and a cover, comprising: bonding the base and the cover to each other to house the function element inside the cavity; and forming a protection film with which a principal surface of the base, a bonding boundary portion between the principal surface of the base and the cover, and the cover are coated continuously, wherein the protection film is an inorganic material film or an organic semiconductor film.

In the physical quantity sensor manufactured by using this method, since the principal surface of the base, the bonding boundary portion, and the cover are coated continuously with the protection film, it is possible to decrease the possibility that the cover might come off from the base.

### APPLICATION EXAMPLE 5

The method for manufacturing the physical quantity sensor according to this application example may further comprise: forming a wiring line in a wiring groove that is in communication with the cavity; wherein, when the protection film is formed, the wiring groove and the wiring line gets covered by the protection film.

In this physical quantity sensor manufacturing method, it is possible to seal the wiring groove in the process of forming the protection film.

### APPLICATION EXAMPLE 6

The method for manufacturing the physical quantity sensor according to this application example may further comprise: partial cover removal, wherein the base has a pad; wherein the pad gets covered by the cover when the function element gets housed; and, wherein a pad-covering part of the cover, by which the pad is covered, is removed after the forming of the protection film.

In this physical quantity sensor manufacturing method, in the process of forming the protection film, the pad is covered by the cover; therefore, it is possible to avoid the protection film from being formed on the pad.

### APPLICATION EXAMPLE 7

Electronic equipment according to an application example includes the physical quantity sensor according to any of the above examples.

The electronic equipment includes the above physical quantity sensor, which can decrease the possibility that the cover might come off from the base.

### APPLICATION EXAMPLE 8

A movable body according to an application example includes the physical quantity sensor according to any of the above examples.

The movable body includes the above physical quantity sensor, which can decrease the possibility that the cover might come off from the base.

### BRIEF DESCRIPTION OF THE DRAWINGS

The invention will be described with reference to the accompanying drawings, wherein like numbers reference like elements.

FIG. 1 is a schematic sectional view of a physical quantity sensor according to an embodiment.

FIG. 2 is a schematic plan view of the physical quantity sensor of the embodiment.

FIG. 3 is a schematic plan view of the physical quantity sensor of the embodiment.

FIG. 4 is a flowchart that illustrates an example of a method for manufacturing the physical quantity sensor of the embodiment.

FIG. 5 is a schematic sectional view of a process of manufacturing the physical quantity sensor of the embodiment.

FIG. 6 is a schematic sectional view of a process of manufacturing the physical quantity sensor of the embodiment.

FIG. 7 is a schematic sectional view of a process of manufacturing the physical quantity sensor of the embodiment.

FIG. 8 is a schematic sectional view of a process of manufacturing the physical quantity sensor of the embodiment.

FIG. 9 is a schematic sectional view of a process of manufacturing the physical quantity sensor of the embodiment.

FIG. 10 is a schematic sectional view of a process of manufacturing the physical quantity sensor of the embodiment.

FIG. 11 is a schematic sectional view of a process of manufacturing the physical quantity sensor of the embodiment.

FIG. 12 is a schematic sectional view of a process of manufacturing the physical quantity sensor of the embodiment.

FIG. 13 is a schematic sectional view of a process of manufacturing the physical quantity sensor of the embodiment.

FIG. 14 is a schematic sectional view of a process of manufacturing the physical quantity sensor of the embodiment.

FIG. 15 is a schematic sectional view of a process of manufacturing the physical quantity sensor of the embodiment.

FIG. 16 is a schematic sectional view of a physical quantity sensor according to a variation example of the embodiment.

FIG. 17 is a function block diagram of electronic equipment according to an embodiment.

FIG. 18 is a diagram that illustrates an example of the appearance of a smartphone, which is an example of the electronic equipment.

FIG. 19 is a diagram that illustrates an example of the appearance of a wristwatch-type wearable device, which is an example of the electronic equipment.

FIG. 20 is a diagram that illustrates a movable body according to an embodiment.

### DESCRIPTION OF EXEMPLARY EMBODIMENTS

With reference to the accompanying drawings, preferred embodiments of the present invention will now be explained in detail. The specific embodiments described below are not intended for undue limitation of the scope of the invention recited in the appended claims. For implementation of the invention, it is not always necessary and essential to combine all of elements described below.

1. Physical Quantity Sensor

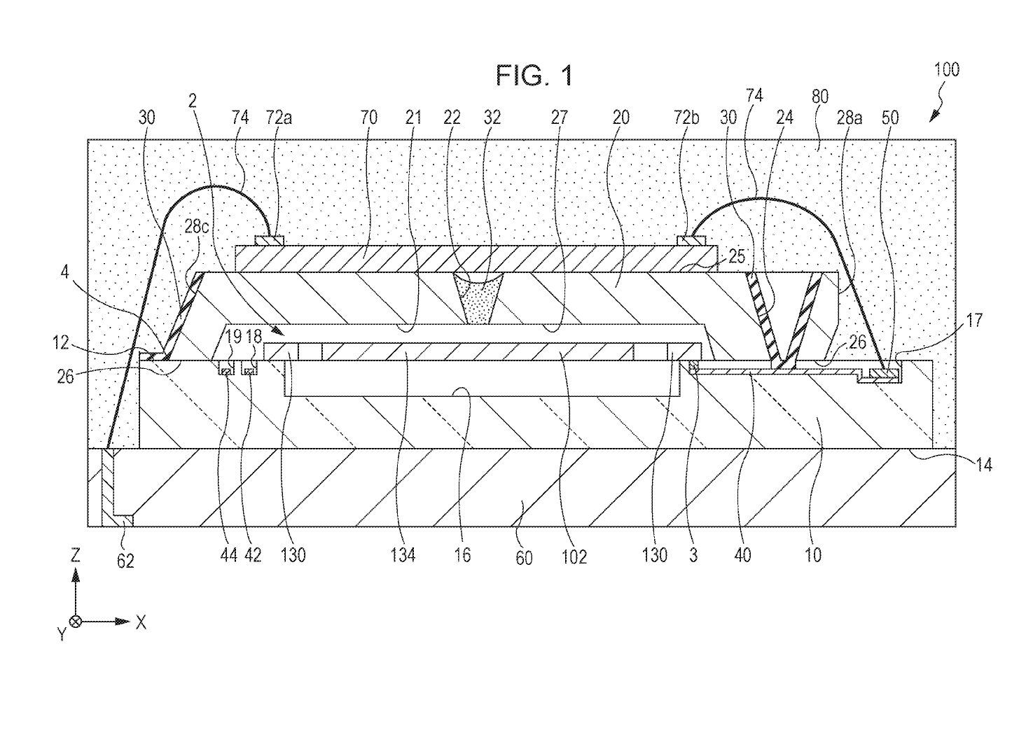

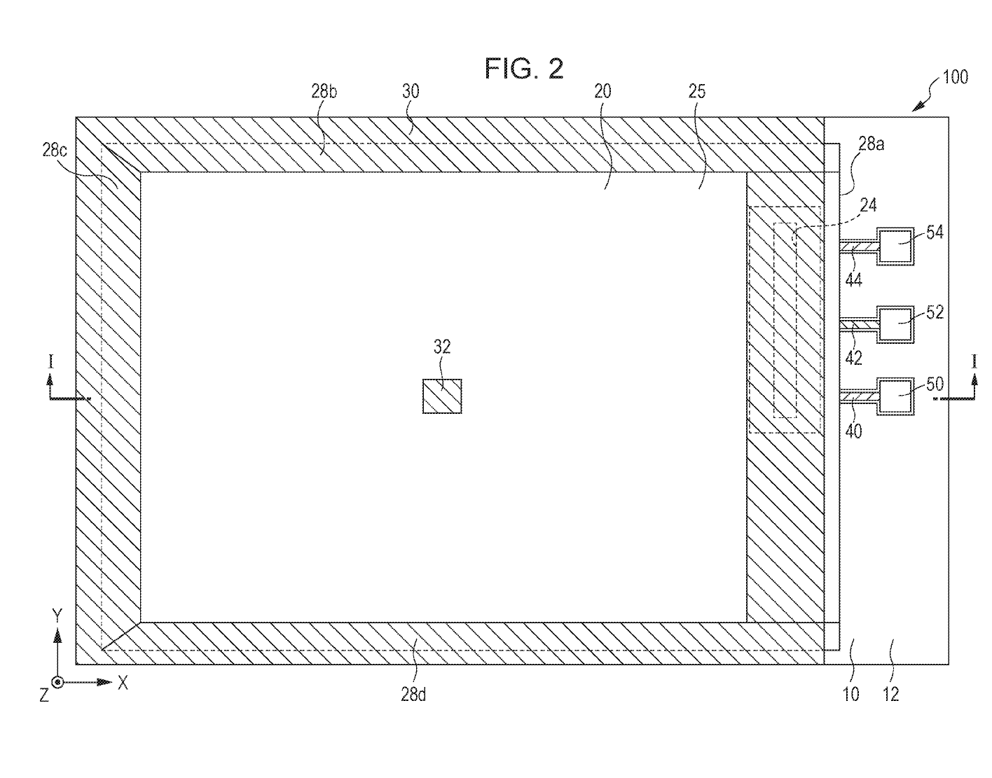

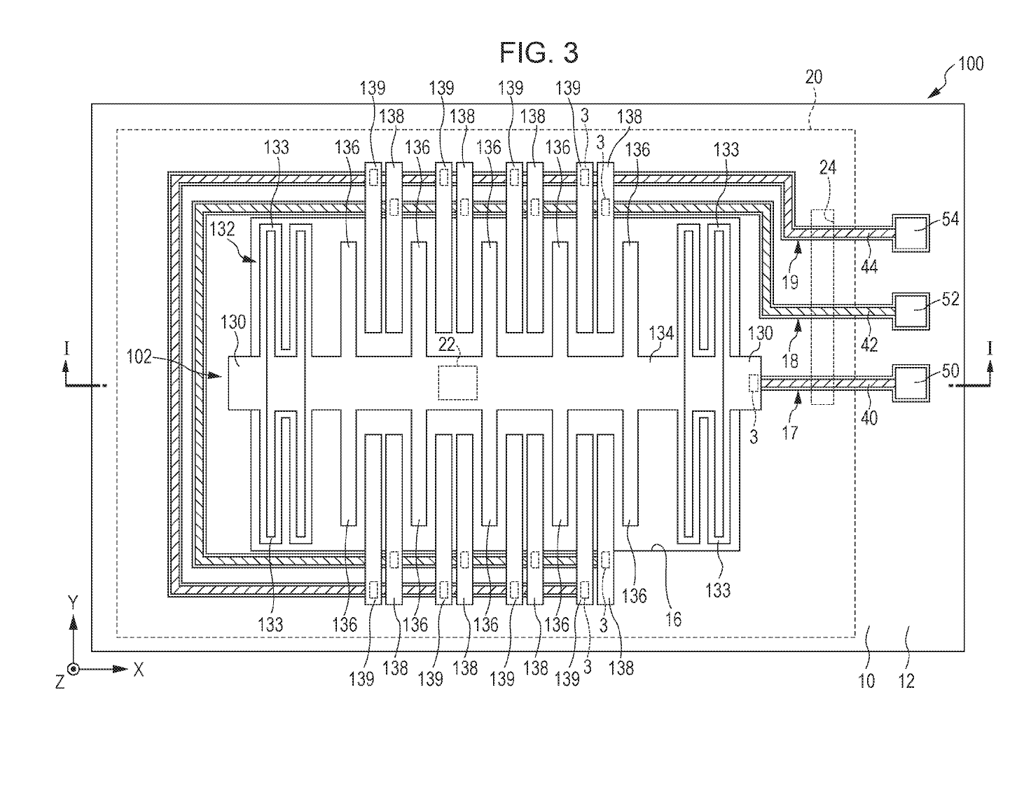

First, with reference to the accompanying drawings, a physical quantity sensor according to the present embodiment will now be explained. FIG. 1 is a schematic sectional view of a physical quantity sensor 100 according to the present embodiment. FIGS. 2 and 3 are schematic plan views of the physical quantity sensor 100 of the embodiment. The cross section of FIG. 1 is taken along the line I-I in FIGS. 2 and 3. As three axes that are orthogonal to one another, X, Y, and Z axes are shown in FIGS. 1, 2, and 3.

The physical quantity sensor 100 is, for example, an acceleration sensor or a gyrosensor. In the description below, as the physical quantity sensor 100, an acceleration sensor that detects acceleration in the X direction is explained.

As illustrated in FIGS. 1, 2, and 3, the physical quantity sensor 100 includes a base 10, a cover 20, a protection film 30, a sealant 32, wiring lines 40, 42, and 44, pads 50, 52, and 54, a wiring board (interposer board) 60, an IC chip (electronic circuit) 70, resin (mold resin) 80, and a function element 102. To facilitate understanding, the wiring board 60, the IC chip 70, and the resin 80 are omitted in FIG. 2. The protection film 30, the sealant 32, the wiring board 60, the IC chip 70, and the resin 80 are omitted in FIG. 3, with see-through illustration of the cover 20.

The material of the base 10 is, for example, glass or silicon. A concave portion 16 is formed in the upper surface (principal surface) 12 of the base 10. The movable body 134 of the function element 102 is provided over the concave portion 16 (at the +Z-directional side). The concave portion 16 is a part of a cavity 2.

Wiring grooves 17, 18, and 19 are formed in the upper surface 12 of the base 10. The wiring grooves 17, 18, and 19 are in communication with the cavity 2. The wiring groove 17, 18, 19 has, for example, in plan view (when viewed in the Z direction), an area overlapping with the cover 20 and an area not overlapping with the cover 20.

The cover 20 is provided on and over the base 10 (at the +Z-directional side). The material of the cover 20 is, for example, silicon or glass. The cover 20 is bonded to the base 10. In the illustrated example, the lower surface 26 of the cover 20 is bonded to the upper surface 12 of the base 10. If the material of the cover 20 is silicon and if the material of the base 10 is glass, for example, the base 10 and the cover 20 are bonded to each other by anodic bonding. In the illustrated example, the cover 20 has a concave portion 21. The concave portion 21 is another part of the cavity 2.

The method of the bonding of the base 10 and the cover 20 is not specifically limited. For example, it may be low-melting glass (glass paste) bonding, or soldering. Alternatively, the base 10 and the cover 20 may be bonded to each other by eutectic bonding, in which a thin metal film (not illustrated) is formed on the bonding portion of each of the base 10 and the cover 20, and in which the two thin metal films are bonded to each other.

As illustrated in FIG. 2, the cover 20 is rectangular in plan view, and has four lateral faces (+X-directional lateral face 28a, +Y-directional lateral face 28b, −X-directional lateral face 28c, and −Y-directional lateral face 28d). Among these four sides 28a, 28b, 28c, and 28d, no protection film 30 is formed on the side (+X-directional lateral face) 28a, which is closest to the pads 50, 52, and 54. The protection film 30 is formed on each of the other sides, 28b, 28c, and 28d. Each of the sides 28b, 28c, and 28d is sloped with respect to the upper surface 12 of the base 10. Because of the sloped structure, it is easy to form the protection film 30 on the sides 28b, 28c, and 28d.

The cover 20 has a first through hole 22 and a second through hole 24.

The first through hole 22 is in communication with the cavity 2. The first through hole 22 goes through the cover 20 in the thickness direction (in the Z direction). Specifically, the first through hole 22 goes from the upper surface 25 of the cover 20 to the inner bottom surface 27 thereof at the concave portion 21 (surface defining the concave portion 21, surface oriented in the opposite direction in relation to the upper surface 25).

Preferably, the first through hole 22 should have, for example, a tapered shape whose opening diameter decreases toward the cavity 2 (from the upper surface 25 of the cover 20 to the inner bottom surface 27 thereof at the concave portion 21). With such a tapered structure, it is possible to prevent a solder ball from dropping in the process of forming the sealant 32, with which the first through hole 22 is sealed as described later. Moreover, in the process of forming the sealant 32, it is possible to seal the first through hole 22 more reliably.

The second through hole 24 is formed at a position where it overlaps with the wiring grooves 17, 18, and 19 in plan view. The second through hole 24 is formed over the wiring grooves 17, 18, and 19 (over the wiring lines 40, 42, and 44). The second through hole 24 goes through the cover in the thickness direction (in the Z direction). Specifically, the second through hole 24 goes from the upper surface 25 of the cover 20 to the lower surface 26 thereof. Preferably, the second through hole 24 should have, for example, a tapered shape whose opening diameter decreases toward the base 10 (from the upper surface 25 of the cover 20 to the lower surface 26 thereof). With such a tapered structure, it is easier to form the protection film 30 throughout the hole, including the bottom portion of the hole, and it is possible to seal the wiring grooves 17, 18, and 19 with the protection film 30 more reliably.

In the illustrated example, there is a single second through hole 24 overlapping with the wiring grooves 17, 18, and 19 in plan view. Though not illustrated, however, the second through hole 24 may be plural holes corresponding respectively to the plural wiring grooves 17, 18, and 19. Such a multiple-hole structure increases the bonding area size of the base 10 and the cover 20, thereby increasing bonding strength.

The upper surface 12 of the base 10, a bonding boundary portion 4 between the upper surface 12 of the base 10 and the cover 20, and the cover 20 (the sides 28b, 28c, and 28d of the cover 20) are coated continuously with the protection film 30. In the illustrated example, the bonding boundary portion 4 is the bonding boundary between the upper surface 12 of the base 10 and the lower surface 26 of the cover 20. The bonding boundary portion 4 is coated with the protection film 30 from the outside (the opposite of the cavity side 2). Since the upper surface 12 of the base 10, the bonding boundary portion 4, and the cover 20 are coated continuously with the protection film 30, it is possible to ensure that the bonding boundary portion 4 (bonding portion) between the base 10 and the cover 20 is not exposed.

Though not illustrated, if the base 10 and the cover 20 are bonded to each other by means of a bonding material that has thickness, for example, low-melting glass, the bonding boundary portion 4 includes the bonding boundary between the bonding material and the upper surface 12 of the base 10, the bonding material (the side of the bonding material), and the bonding boundary between the bonding material and the lower surface 26 of the cover 20.

The protection film 30 is formed inside the second through hole 24 and the wiring grooves 17, 18, and 19, too, and the wiring grooves 17, 18, and 19 and the wiring lines 40, 42, and 44 are covered by the protection film 30 at this area. In the illustrated example, the protection film 30 is directly on the wiring lines 40, 42, and 44 at this area (that is, without anything sandwiched therebetween). For covering the wiring lines 40, 42, and 44 indirectly by the protection film 30, an insulation film (not illustrated) may be sandwiched therebetween. The wiring grooves 17, 18, and 19 are sealed with the protection film 30. Because of the sealing of the wiring grooves 17, 18, and 19 with the protection film 30, the cavity 2 is in a sealed state (a space that is hermetically closed). That is, the protection film 30 has another function of sealing the wiring grooves 17, 18, and 19.

The protection film 30 is not formed on/over the pads 50, 52, and 54. In the example illustrated in FIG. 2, the protection film 30 is not formed at any area closer to the pads 50, 52, and 54 than the area of the cover 20 is (at the +X-directional side), over the upper surface 12 of the base 10. Moreover, in the illustrated example, the protection film 30 is not formed on the side 28a, which is closest to the pads 50, 52, and 54 among the four sides of the cover 20.

The protection film 30 is, for example, an inorganic material film or an organic semiconductor film. More specifically, examples of the material of the protection film 30 are: oxide such as SiO₂, nitride such as SiN, metal, DLC (Diamond Like Carbon), anthracene, tetracyanoquinodimethane (TCNQ), polyacethylene, poly-3-hexylthiophene (P3HT), polyparaphenylene vinylene (PPV), etc. A SiO₂ film used as the protection film 30 is, for example, a CVD film made of TEOS (Tetra Ethyl Ortho Silicate). Preferably, a film that is made of the same material as that of the base 10 and the cover 20, for example, a film whose coefficient of thermal expansion is close to that of the base 10 and the cover 20, should be used as the protection film 30. For example, if the material of the base 10 is glass and if the material of the cover 20 is silicon, preferably, a SiO₂ film should be used as the protection film 30. By this means, it is possible to reduce stress that occurs in the protection film 30. The thickness of the protection film 30 is, for example, not less than 1 μm but not greater than 5 μm.

The sealant 32 is provided inside the first through hole 22. The first through hole 22 is filled with the sealant 32. The sealant 32 is the sealer of the first through hole 22. Because of the sealing of the through hole 22 with the sealant 32, the cavity 2 is in a sealed state (a space that is hermetically closed). The material of the sealant 32 is, for example, alloy such as AuGe or SnPb.

The first wiring line 40 is provided in the first wiring groove 17. The first wiring line 40 is electrically connected to the function element 102 via a contact portion 3. The first wiring line 40 is electrically connected to the movable body 134 of the function element 102.

The second wiring line 42 is provided in the second wiring groove 18. The second wiring line 42 is connected to first fixed electrode portions 138 of the function element 102 via contact portions 3. The second wiring line 42 is routed in such a way as to surround the concave portion 16 in plan view.

The third wiring line 44 is provided in the third wiring groove 19. The third wiring line 44 is connected to second fixed electrode portions 139 of the function element 102 via contact portions 3. The third wiring line 44 is routed in such a way as to surround the concave portion 16 in plan view.

The pads 50, 52, and 54 are connected to the wiring lines 40, 42, and 44 respectively. For example, the pads 50, 52, and 54 are provided on the wiring lines 40, 42, and 44 respectively. The pads 50, 52, and 54 are provided at respective positions where they do not overlap with the cover 20 in plan view.

The material of the wiring lines 40, 42, and 44, the pads 50, 52, and 54, and the contact portions 3 (hereinafter referred to also as “wiring line 40, etc.”) is, for example, aluminum, gold, or ITO (Indium Tin Oxide). Since a transparent electrode material such as ITO, etc. is used as the material of the wiring line 40, etc., a foreign object, etc. that exists on the wiring line 40, etc. can be visually recognized easily from below the lower surface 14 of the base 10.

The base 10 is on the wiring board (interposer board) 60. An external terminal 62 is provided in the wiring board 60.

The IC chip (electronic circuit) 70 is mounted on the cover 20. The IC chip 70 processes, for example, a signal outputted from the function element 102. In the illustrated example, the terminal 72a of the IC chip 70 is electrically connected to the external terminal 62 via a bonding wire 74. The terminal 72b of the IC chip 70 is electrically connected to the pad 50 via another bonding wire 74.

The base 10, the cover 20, the protection film 30, the IC chip 70, and the bonding wires 74 are covered by the (mold) resin 80. The resin 80 protects them against external stress, moisture, contaminants, and the like. In the physical quantity sensor 100, since the bonding boundary portion 4 is coated with the protection film 30, it is possible to prevent the resin 80 from getting into the cavity 2.

The function element 102 is provided at the upper-surface side 12 of the base 10. The function element 102 is bonded to the base 10 by, for example, anodic bonding or direct bonding. The function element 102 is housed (provided) inside the cavity 2 formed by the base 10 and the cover 20. The cavity 2 is hermetically closed in inactive gas atmosphere (for example, nitrogen gas atmosphere).

The function element 102 includes fixed portions 130, spring portion 132, the movable body 134, movable electrode portions 136, and the fixed electrode portions 138 and 139. The spring portion 132, the movable body 134, and the movable electrode portions 136 are provided over the concave portion 16 at a distance from the base 10.

The fixed portions 130 are fixed to the base 10. For example, the fixed portions 130 are bonded to the upper surface 12 of the base 10 by anodic bonding. The fixed portions 130 are provided across the edges of the concave portion 16 in plan view. For example, two fixed portions 130 are provided. In the illustrated example, one of the fixed portions 130 is provided at the −X-directional side with respect to the movable body 134, and the other of the fixed portions 130 is provided at the +X-directional side with respect to the movable body 134.

The spring portion 132 connects the fixed portions 130 to the movable body 134. The spring portion 132 is made up of plural meandering portions 133. Each of the meandering portions 133 runs in the X direction by coming and going in the Y direction in a zigzag manner. The meandering portions 133 (spring portion 132) can extend and contract smoothly in the X direction, that is, the direction in which the position of the movable body 134 changes.

The shape of the movable body 134 in plan view (when viewed in the Z direction) is, for example, a rectangle whose longer sides go along the X axis. The position of the movable body 134 is variable in the X direction. Specifically, the movable body 134 changes its position in the X direction in accordance with acceleration in the X direction while causing the spring portion 132 to deform elastically. The movable body 134 is electrically connected to the first wiring line 40 via the spring portion 132, the fixed portion 130, and the contact portion 3.

The movable electrode portions 136 are provided on the movable body 134. In the illustrated example, ten movable electrode portions 136 are provided; five movable electrode portions 136 extend from the movable body 134 in the +Y direction, and the remaining five movable electrode portions 136 extend from the movable body 134 in the −Y direction. The movable electrode portions 136 are electrically connected to the first wiring line 40 via the movable body 134, etc.

The fixed electrode portions 138 and 139 are fixed to the base 10. For example, the fixed electrode portions 138 and 139 are bonded to the upper surface 12 of the base by anodic bonding. One end of the fixed electrode portion 138, 139 is bonded to the upper surface 12 of the base 10 as a fixed end, and the other end thereof extends toward the movable body 134 as a free end. The fixed electrode portions 138 and 139 are provided opposite the movable electrode portions 136. In the example illustrated in FIG. 3, the fixed electrode portions 138 and 139 are provided alternately as viewed along the X axis. The first fixed electrode portions 138 are electrically connected to the second wiring line 42 via the contact portions 3. The second fixed electrode portions 139 are electrically connected to the third wiring line 44 via the contact portions 3.

The fixed portions 130, the spring portion 132, the movable body 134, and the movable electrode portions 136 are formed as a single integrated member. The material of the fixed portions 130, the spring portion 132, the movable body 134, the movable electrode portions 136, and the fixed electrode portions 138 and 139 is silicon to which electric conductivity is applied by doping impurities, for example, phosphorus or boron.

Next, the operation of the physical quantity sensor 100 will now be explained.

In the physical quantity sensor 100, when acceleration occurs in the X direction, the movable body 134 changes its position in the X direction while causing the spring portion 132 to deform elastically. Due to the change in the position of the movable body 134, the distance between the movable electrode portions 136 and the fixed electrode portions 138 and the distance between the movable electrode portions 136 and the fixed electrode portions 139 change. That is, due to the change in the position of the movable body 134, electrostatic capacity between the movable electrode portions 136 and the fixed electrode portions 138 and electrostatic capacity between the movable electrode portions 136 and the fixed electrode portions 139 change. By detecting these changes in electrostatic capacity, it is possible to measure acceleration in the X direction. In the physical quantity sensor 100, the electrostatic capacity can be measured via the pads 50, 52, and 54.

Though the physical quantity sensor 100 described above is an acceleration sensor that detects acceleration in the X direction, a physical quantity sensor according to the present invention may be an acceleration sensor that detects acceleration in the Y direction or an acceleration sensor that detects acceleration in the Z direction.

For example, the physical quantity sensor 100 has the following features.

In the physical quantity sensor 100, the upper surface (principal surface) 12 of the base 10, the bonding boundary portion 4 between the upper surface (principal surface) 12 of the base 10 and the cover 20, and the cover are coated continuously with the protection film 30. Therefore, it is possible to decrease the possibility that the cover 20 might come off from the base 10. Moreover, because of the continuous coating of the upper surface 12 of the base 10, the bonding boundary portion 4, and the cover 20 with the protection film 30, it is possible to decrease the possibility that the base 10, the cover 20, and the bonding portion of them might be damaged due to chipping, etc. in the process of dicing into pieces described later.

In the physical quantity sensor 100, the protection film 30 is an inorganic material film or an organic semiconductor film. Therefore, for example, as compared with a case where the protection film is made of resin, it is possible to provide more reliable protection of the bonding boundary portion 4 without any deformation even if placed in a high-temperature environment or even if heat is applied thereto during manufacturing. In the physical quantity sensor 100, if the material of the base 10 is glass and if the material of the cover 20 is silicon, SiO₂ can be used as a preferred film material of the protection film 30. As compared with a case where the protection film is made of, for example, resin, the use of a SiO₂ film makes the difference in the coefficient of thermal expansion from that of the base 10 and the cover 20 smaller, thereby making film stress smaller. By this means, it is possible to decrease the possibility that the base 10 might come off from the cover 20. Moreover, it is possible to decrease the possibility of deterioration in the characteristics of the function element 102 due to the warping of the base 10 caused by film stress.

In the physical quantity sensor 100, the wiring grooves 17, 18, and 19, which are in communication with the cavity 2, and the wiring lines 40, 42, and 44, which are provided in the wiring grooves 17, 18, and 19 respectively, are covered by the protection film 30. It is possible to seal the cavity 2 by covering the wiring lines 40, 42, and 44 and the wiring grooves 17, 18, and 19 by the protection film 30. That is, the protection film 30 functions also as a sealing material that seals the cavity 2.

If the protection film is made of, for example, resin, it cannot be used as a sealing material because of resin's permeability to air and because of an outgas problem. In contrast, in the physical quantity sensor 100, since the protection film 30 is an inorganic material film or an organic semiconductor film, it is possible to use the protection film 30 as a sealing material without any of these problems.

2. Method for Manufacturing Physical Quantity Sensor

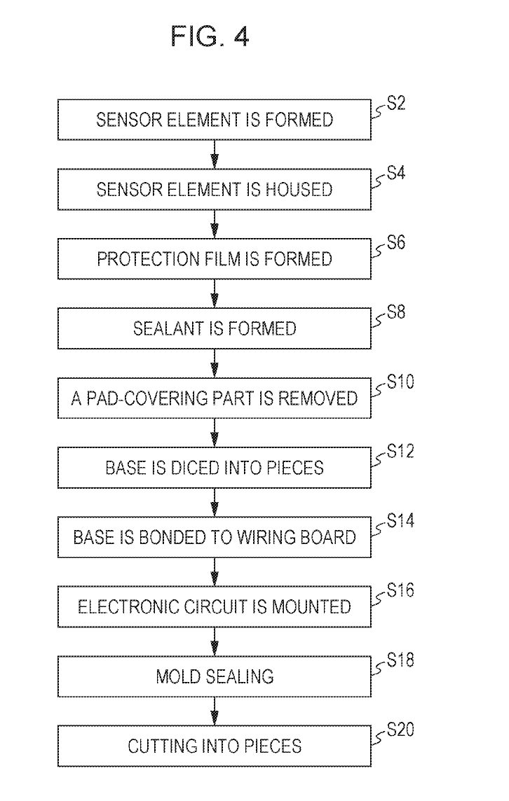

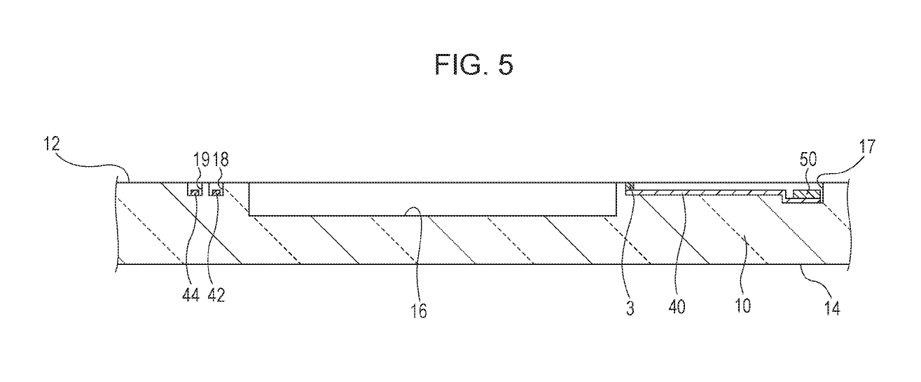

Next, with reference to the accompanying drawings, a method for manufacturing a physical quantity sensor 100 according to the present embodiment will now be explained. FIG. 4 is a flowchart that illustrates an example of a method for manufacturing the physical quantity sensor 100 of the embodiment. FIGS. 5 to 16 are schematic sectional views of the processes of manufacturing the physical quantity sensor 100 of the embodiment.

The function element 102 is formed at the upper-surface side 12 of the base 10 (Step S2).

Specifically, first, as illustrated in FIG. 5, the base (glass substrate) 10 is patterned to form the concave portion 16 and the wiring grooves 17, 18, and 19. For example, photolithography and etching are used for the patterning. Next, the wiring lines 40, 42, and 44 are formed in the wiring grooves 17, 18, and 19 respectively. Next, the pads 50, 52, and 54 are formed on the wiring lines 40, 42, and 44 respectively. Next, the contact portions 3 are formed on the wiring lines 40, 42, and 44. The wiring lines 40, 42, and 44, the pads 50, 52, and 54, and the contact portions 3 are formed by film formation using a sputtering method or a vapor phase growth method and by patterning. Examples of the vapor phase growth method are: CVD (Chemical Vapor Deposition), which is a chemical vapor phase growth method, PVD (Physical Vapor Deposition), which is a physical vapor phase growth method, and ALD, that is, an atomic layer deposition method. Alternatively, with the use of these methods, a composite thin film of the wiring lines 40, 42, and 44, the pads 50, 52, and 54, and the contact portions 3 may be formed. The sequential order of forming the pads 50, 52, and 54 and the contact portions 3 is not specifically limited.

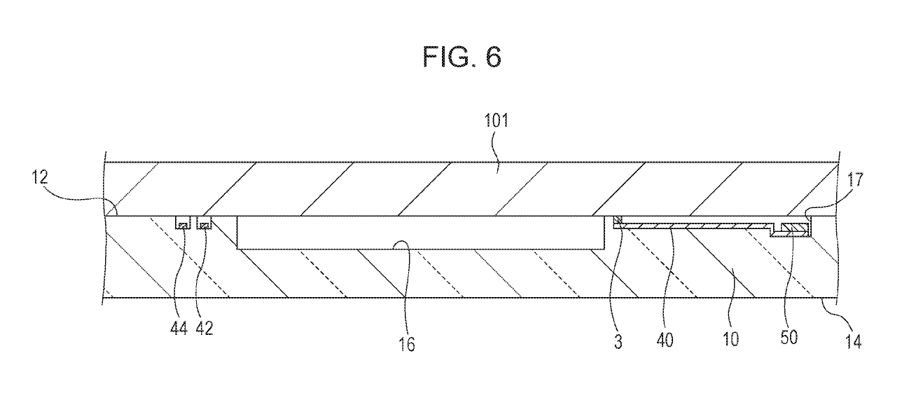

As illustrated in FIG. 6, a silicon substrate 101 is bonded to the upper surface 12 of the base 10. For example, the base 10 and the silicon substrate 101 are bonded to each other by anodic bonding. This ensures strong bonding of the base 10 and the silicon substrate 101 to each other.

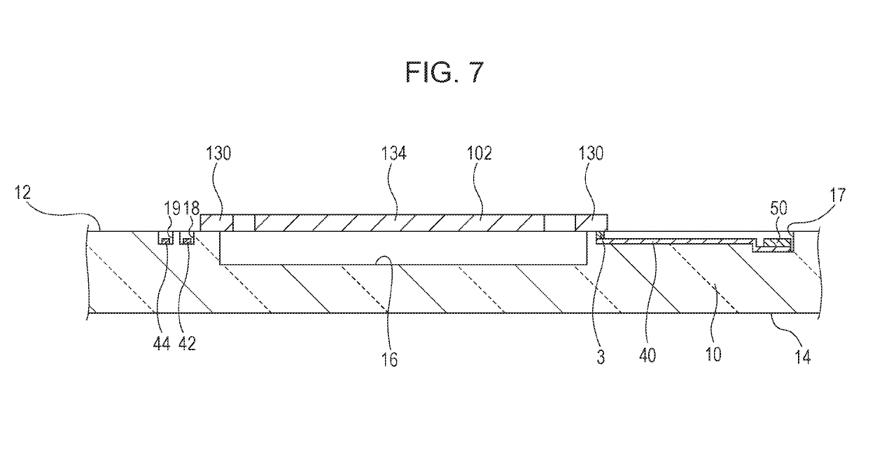

The silicon substrate 101 is, for example, ground by means of a grinding machine to turn into a thin film. After the grinding, as illustrated in FIG. 7, the thin film is patterned into a predetermined shape so as to form the function element 102. Photolithography and etching (dry etching) are used for the patterning. A specific example of the method of the etching is Bosch etching.

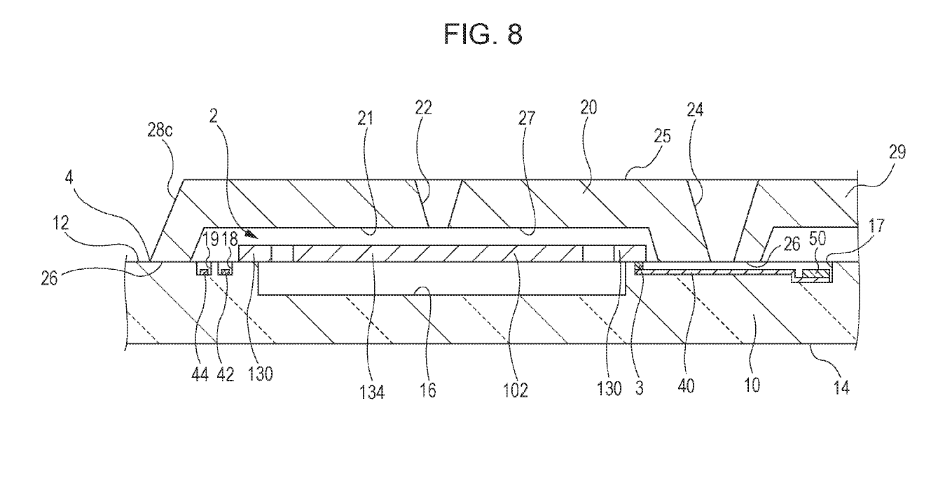

Next, as illustrated in FIG. 8, the base 10 and the cover 20 are bonded to each other to house the function element 102 inside the cavity 2 formed by the base 10 and the cover 20 (Step S4).

For example, the base 10 and the cover 20 are bonded to each other by anodic bonding. This ensures strong bonding of the base 10 and the cover 20 to each other.

As illustrated in FIG. 8, the cover 20 has a cover portion 29 overhanging the pads 50, 52, and 54. The cover portion 29 of the cover 20 is a portion overlapping with the pads 50, 52, and 54 in plan view when the base 10 and the cover 20 are bonded to each other. As a result of the bonding of the base 10 and the cover 20 to each other in this process, the pads 50, 52, and 54 are under the cover portion 29 of the cover 20. In a state in which the base 10 and the cover 20 are bonded to each other, the cover portion 29 of the cover 20 is not in contact with the pads 50, 52, and 54.

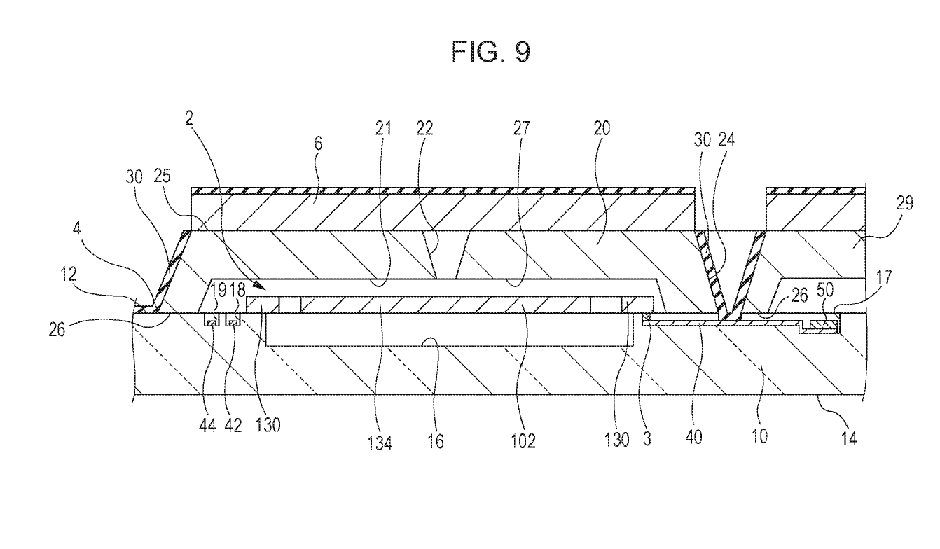

Next, as illustrated in FIG. 9, the protection film 30 is formed, wherein the upper surface 12 of the base 10, the bonding boundary portion 4 between the base 10 and the cover 20, and the cover 20 are coated continuously therewith (Step S6).

Specifically, first, a mask 6 is laid on the upper surface 25 of the cover 20 to close the first through hole 22. Next, to form the protection film 30, a TEOS film is formed by using a vapor phase growth method (for example, CVD), etc. via the mask 6. In this way, the protection film 30, with which the upper surface 12 of the base 10, the bonding boundary portion 4, and the cover 20 are coated continuously, is formed. In addition to the across-the-boundary area mentioned above, in this process, the protection film 30 is formed inside the second through hole 24 and the wiring grooves 17, 18, and 19 to cover the wiring grooves 17, 18, and 19 and the wiring lines 40, 42, and 44. It is possible to seal the wiring grooves 17, 18, and 19 by covering the wiring grooves 17, 18, and 19 and the wiring lines 40, 42, and 44 by the protection film 30. That is, in this process, the effect of protecting the bonding boundary portion 4 between the base 10 and the cover 20 and the effect of sealing the wiring grooves 17, 18, and 19 can be obtained at the same time by forming the protection film 30. After the above process, the mask 6 is removed.

In the process of forming the protection film 30, the pads 50, 52, and 54 are under the cover portion 29 of the cover 20. For this reason, it is possible to avoid the protection film 30 from being formed on the pads 50, 52, and 54.

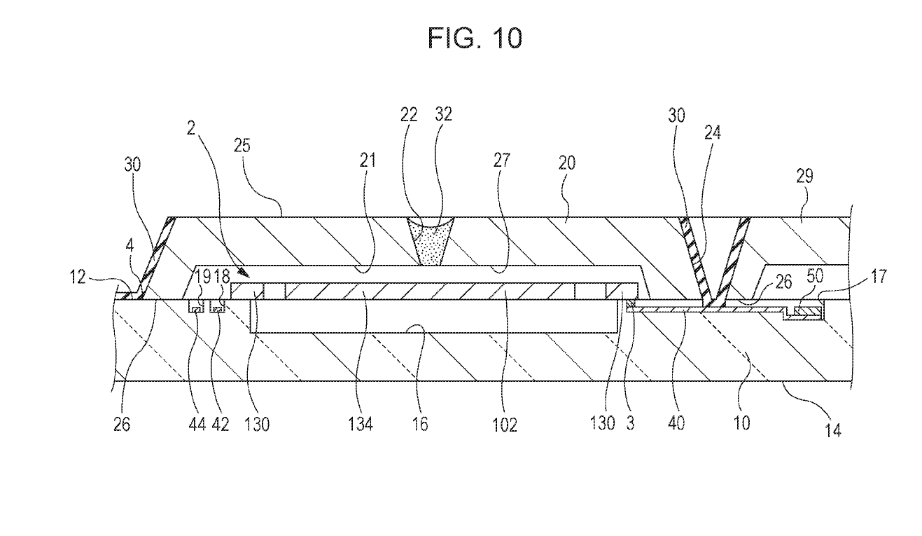

Next, as illustrated in FIG. 10, the sealant 32 for sealing the through hole 22 is formed (Step S8).

Specifically, first, a solder ball is placed in the through hole 22. The solder ball is placed in contact with the inner surface of the through hole 22, which has a tapered shape. The shape of the solder ball is, for example, a sphere. Next, heat is applied to the solder ball to melt it, thereby forming the sealant 32 for sealing the through hole 22. To melt the solder ball, for example, a laser beam of short wavelength, for example, YAG laser or CO₂ laser, is applied to the solder ball. By this means, it is possible to melt the solder ball in a short time. When the laser beam is applied to the solder ball, the base 10 may be heated approximately to the eutectic temperature of the solder ball.

This process is carried out in, for example, inactive gas atmosphere. By this means, it is possible to hermetically close the cavity 2 by means of inactive gas. The viscosity of the inactive gas contributes to the sensitivity characteristics of the physical quantity sensor 100 as damping effects.

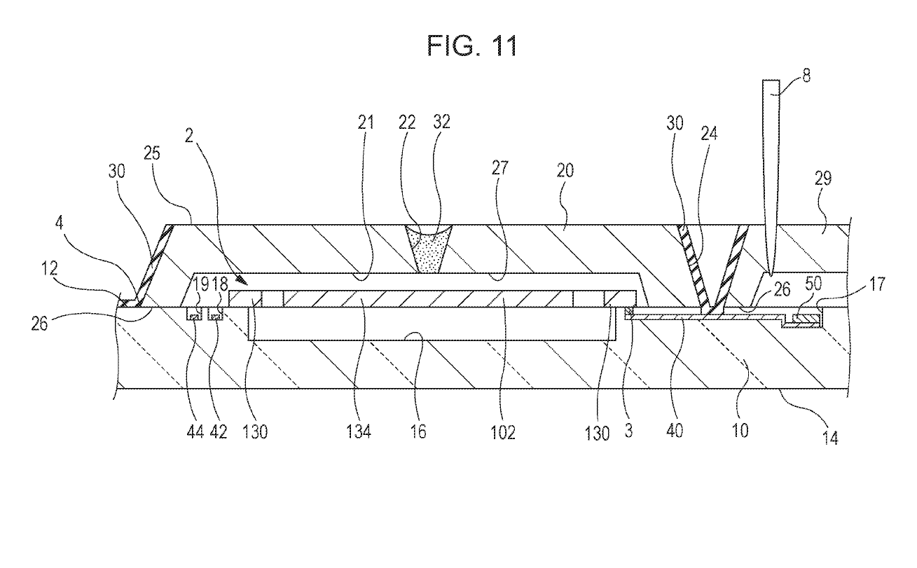

Next, as illustrated in FIG. 11, the cover portion 29 of the cover 20 overhanging the pads 50, 52, and 54 is removed (step S10).

For removing the cover portion 29 of the cover 20, for example, a dicing saw (dicing machine) is used. Specifically, the cover portion 29 only of the cover 20 is cut off (half cut) in such a way that a dicing blade 8 does not reach the base 10, thereby removing the cover portion 29 of the cover 20. By this means, it is possible to expose the pads 50, 52, and 54. The cut surface of the cover 20 in this process of removing the cover portion 29 is the lateral face 28a of the cover 20.

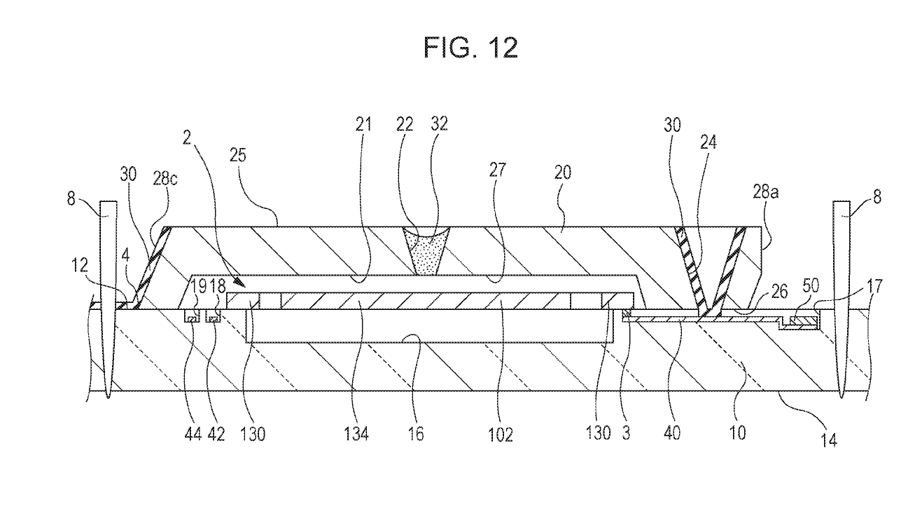

Next, as illustrated in FIG. 12, the base 10 is diced into pieces (Step S12).

Specifically, a dicing saw (dicing machine) is used for dicing into pieces. The dicing is performed by cutting the base 10 in such a way as not to cut the bonding portion of the cover 20 and the base 10. In this process, as illustrated in FIG. 12, because of the existence of the protection film 30, with which the upper surface 12 of the base 10, the bonding boundary portion 4, and the cover 20 are coated continuously, no cutting water is supplied to the bonding boundary portion 4. Therefore, it is possible to decrease the possibility that the base 10 might come off from the cover 20. For this reason, for example, it is possible to cut a region near the bonding portion of the cover 20 and the base 10. By undergoing the dicing process described above, the base (glass substrate) 10 illustrated in FIG. 12 turns into pieces of the base 10, one piece of which is illustrated in FIG. 1.

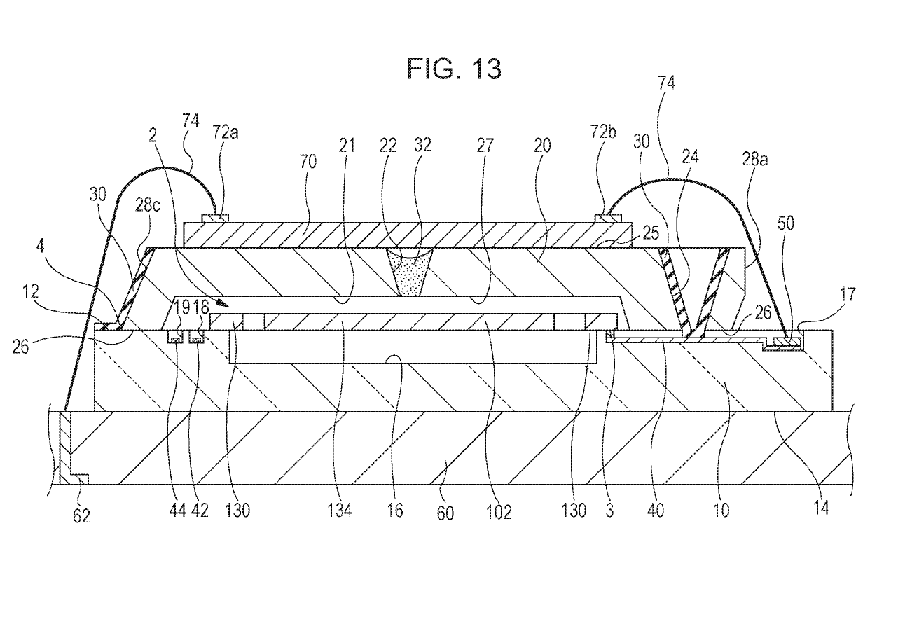

Next, as illustrated in FIG. 13, the base 10 is bonded to the wiring board 60 and is fixed thereon (step S14).

Next, the IC chip (electronic circuit) 70 is mounted on the cover 20 (Step S16).

For example, as illustrated in FIG. 13, the IC chip 70 is fixed to the top of the cover 20, the terminal 72a is electrically connected to the external terminal 62 via a bonding wire 74, and the terminal 72b is electrically connected to the pad 50 via another bonding wire 74.

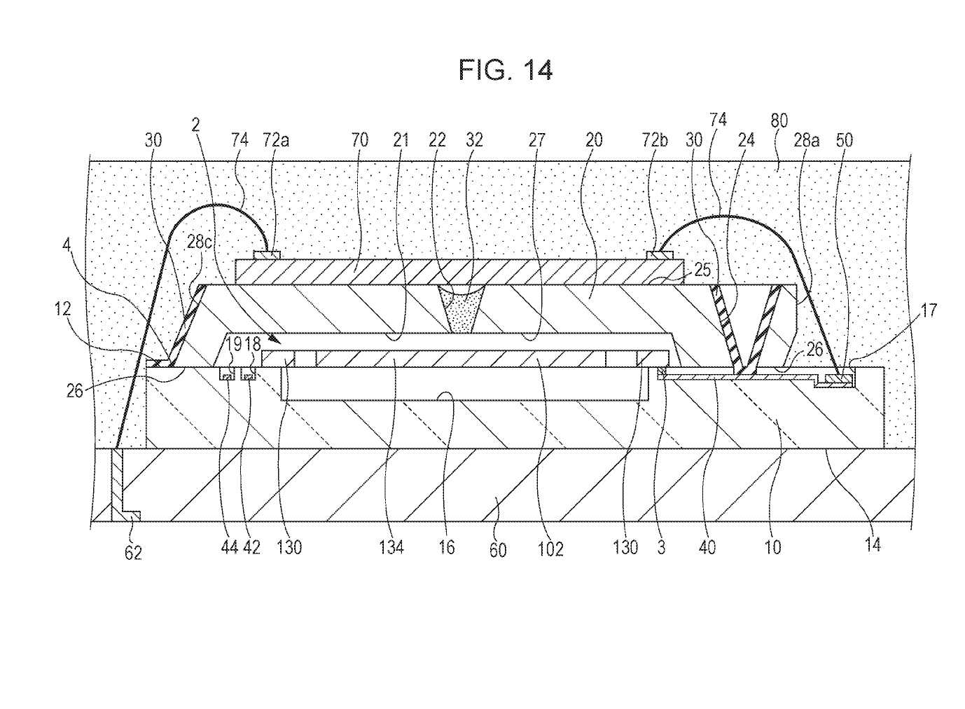

Next, as illustrated in FIG. 14, the resin 80 is molded in such a way as to embed the base 10, the cover 20, the protection film 30, the IC chip 70, and the bonding wires 74 (Step S18). Since the bonding boundary portion 4 is coated with the protection film 30, it is possible to prevent the resin 80 from getting into the cavity 2.

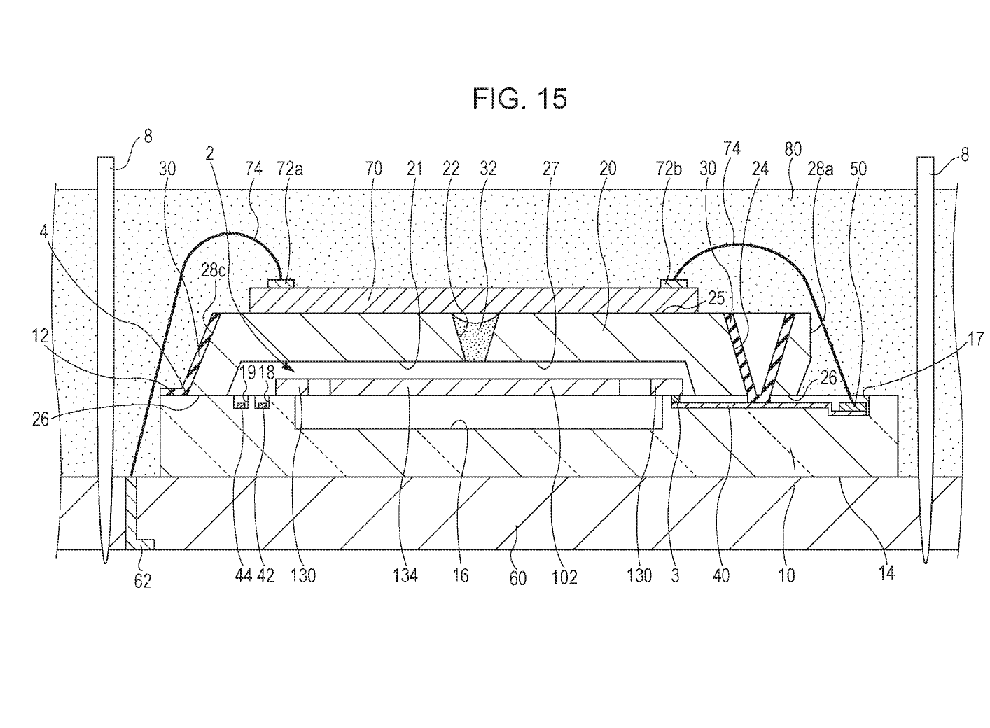

Next, as illustrated in FIG. 15, the physical quantity sensor 100 is produced by dicing into pieces (Step S20). The dicing into pieces is performed by cutting the wiring board 60 and the resin 80 by means of a dicing saw. That is, in this process, the wiring board 60 and the resin 80 are cut without cutting the bonding portion of the cover and the base 10; therefore, it is possible to decrease the possibility that the cover 20 might come off.

Through the processes described above, the physical quantity sensor 100 can be manufactured.

The method for manufacturing the physical quantity sensor 100 includes the process of bonding the base 10 and the cover 20 to each other to house the function element 102 inside the cavity 2 (Step S4) and the process of forming the protection film 30, with which the upper surface (principal surface) 12 of the base 10, the bonding boundary portion 4, and the cover 20 are coated continuously (Step S6). In the physical quantity sensor 100 manufactured by using the method described above, the upper surface 12 of the base 10, the bonding boundary portion 4, and the cover 20 are coated continuously with the protection film 30. Therefore, it is possible to decrease the possibility that the base 10 might come off from the cover 20.

In the method for manufacturing the physical quantity sensor 100, in the process of forming the protection film 30 (Step S6), the wiring grooves 17, 18, and 19 and the wiring lines 40, 42, and 44 get covered by the protection film 30. Therefore, it is possible to seal the wiring grooves 17, 18, and 19 in the process of forming the protection film 30.

In the method for manufacturing the physical quantity sensor 100, the pads 50, 52, and 54 get covered by the cover 20 in the process of housing the function element 102 (Step S4), and, after the process of forming the protection film 30 (Step S6), the cover portion 29 of the cover 20 over the pads 50, 52, and 54 is removed (step S10). As described above, in the method for manufacturing the physical quantity sensor 100, since the pads 50, 52, and 54 are under the cover portion 29 of the cover 20 in the process of forming the protection film 30 (Step S6), it is possible to decrease the possibility that the protection film 30 might be formed on the pads 50, 52, and 54.

3. Variation Example of Physical Quantity Sensor

Next, with reference to the accompanying drawings, a variation example of a physical quantity sensor according to the foregoing embodiment will now be explained. FIG. 16 is a schematic sectional view of a physical quantity sensor 200 according to a variation example of the embodiment. In the physical quantity sensor 200 of the variation example described below, the same reference numerals are assigned to members/portions that have the same functions as those of the constituent members/portions of the physical quantity sensor 100 of the foregoing embodiment, and an explanation of them is omitted.

In the physical quantity sensor 100 described above, as illustrated in FIG. 1, the base 10, the cover 20, the protection film 30, the IC chip 70, and the bonding wires 74 are covered by the resin 80.

In contrast, in the physical quantity sensor 200, as illustrated in FIG. 16, the base 10, the cover 20, the protection film 30, the IC chip 70, and the bonding wires 74 are not covered by any resin. In the physical quantity sensor 200, for example, the base 10, the cover 20, the protection film 30, the IC chip 70, and the bonding wires 74 may be encased in a ceramic package, a glass package, a resin container, or a metal container (not illustrated), etc.

The physical quantity sensor 200 produces the same operational effects as those of the physical quantity sensor 100 described above.

4. Electronic Equipment

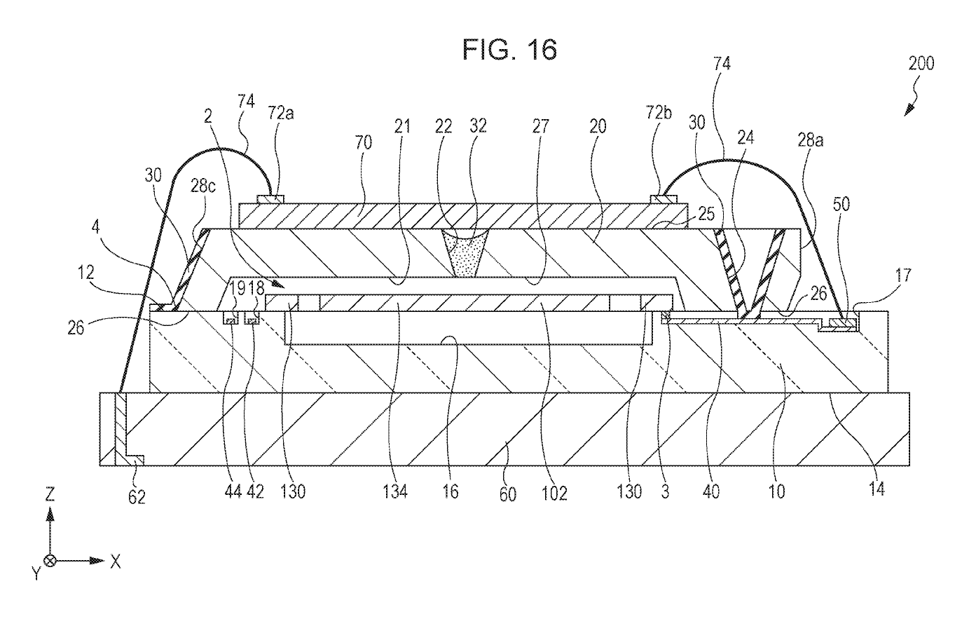

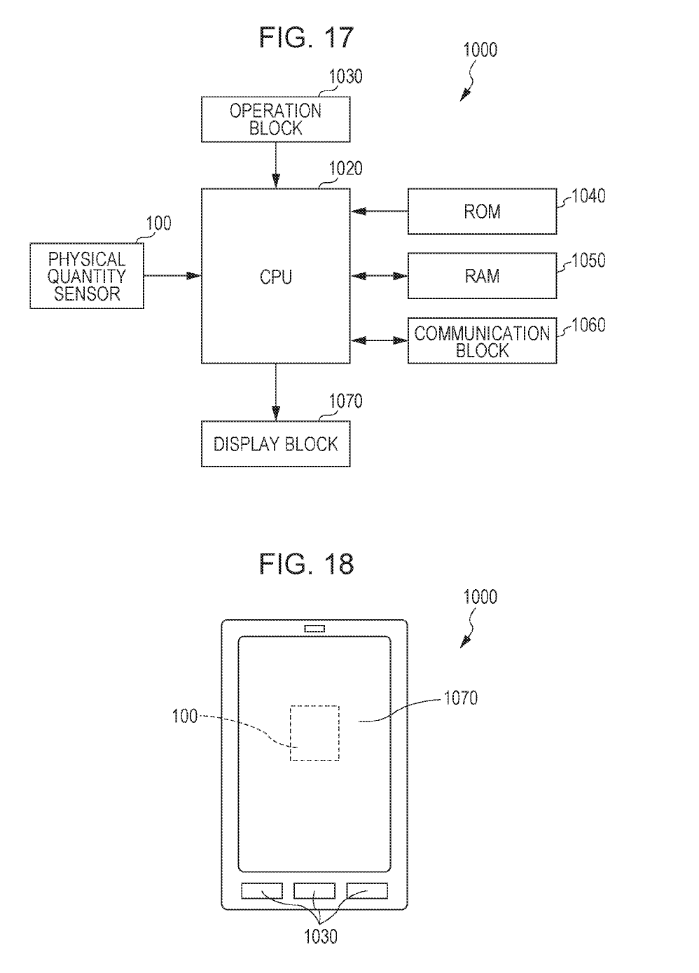

Next, with reference to the accompanying drawings, electronic equipment according to an exemplary embodiment will now be explained. FIG. 17 is a function block diagram of electronic equipment 1000 according to the present embodiment.

The electronic equipment 1000 includes a physical quantity sensor according to some aspects of the invention. In the description below, a case where the electronic equipment 1000 includes the physical quantity sensor 100 is explained.

The electronic equipment 1000 further includes a central processing unit (CPU) 1020, an operation block 1030, a read only memory (ROM) 1040, a random access memory (RAM) 1050, a communication block 1060, and a display block 1070. The electronic equipment of the embodiment may be modified by omitting or changing a part of the constituent elements illustrated in FIG. 17, or by adding any other constituent element thereto.

The CPU 1020 performs various kinds of calculation processing and control processing in accordance with programs stored in the ROM 1040, etc. Specifically, the CPU 1020 performs various kinds of processing in accordance with output signals of the physical quantity sensor 100 and operation signals from the operation block 1030, processing for controlling the communication block 1060 for performing data communication with an external device, and processing for transmitting display signals for displaying various kinds of information to the display block 1070, etc.

The operation block 1030 is an input device that includes operation keys, buttons, and switches, etc., and outputs an operation signal to the CPU 1020 upon operation input by a user.

Programs and data, etc. that are to be used by the CPU 1020 so as to perform various kinds of calculation processing and control processing are stored in the ROM 1040.

The RAM 1050, which is used as the work area of the CPU 1020, temporarily stores programs and data read out of the ROM 1040, data inputted from the physical quantity sensor 100, data inputted from the operation block 1030, and the results of calculation performed by the CPU 1020 in accordance with various programs, etc.

The communication block 1060 performs various kinds of control for data communication between the CPU 1020 and an external device.

The display block 1070 is a display device such as a liquid crystal display (LCD), and displays various kinds of information on the basis of display signals inputted from the CPU 1020. A touch panel functioning as the operation block 1030 may be provided on the display block 1070.

Various electronic devices are conceivable as the electronic equipment 1000. Non-limiting examples are: a personal computer (for example, a mobile personal computer, a laptop personal computer, or a tablet personal computer), a mobile terminal such as a smartphone or a mobile phone, a digital still camera, an ink-jet ejecting apparatus (for example, an ink-jet printer), storage area network equipment such as a router or a switch, local area network equipment, mobile terminal base station equipment, a television, a video camera, a video recorder, a car navigation device, a real-time clock device, a pager, an electronic organizer (including an organizer with a communication function), an electronic dictionary, an electronic calculator, an electronic game machine, a game controller, a word processor, a workstation, a videophone, a security television monitor, a pair of electronic binoculars, a POS terminal, medical equipment (for example, an electronic thermometer, a blood pressure gauge, a blood sugar meter, an electrocardiogram measuring device, an ultrasonic diagnostic device, and an electronic endoscope), a fish finder, various types of measurement equipment, instruments (for example, instruments of a vehicle, an aircraft, or a ship), a flight simulator, a head-mounted display, motion trace, motion tracking, a motion controller, or PDR (Pedestrian Dead Reckoning).

FIG. 18 is a diagram that illustrates an example of the appearance of a smartphone, which is an example of the electronic equipment 1000. The smartphone 1000 is equipped with buttons functioning as the operation block 1030 and an LCD functioning as the display block 1070.

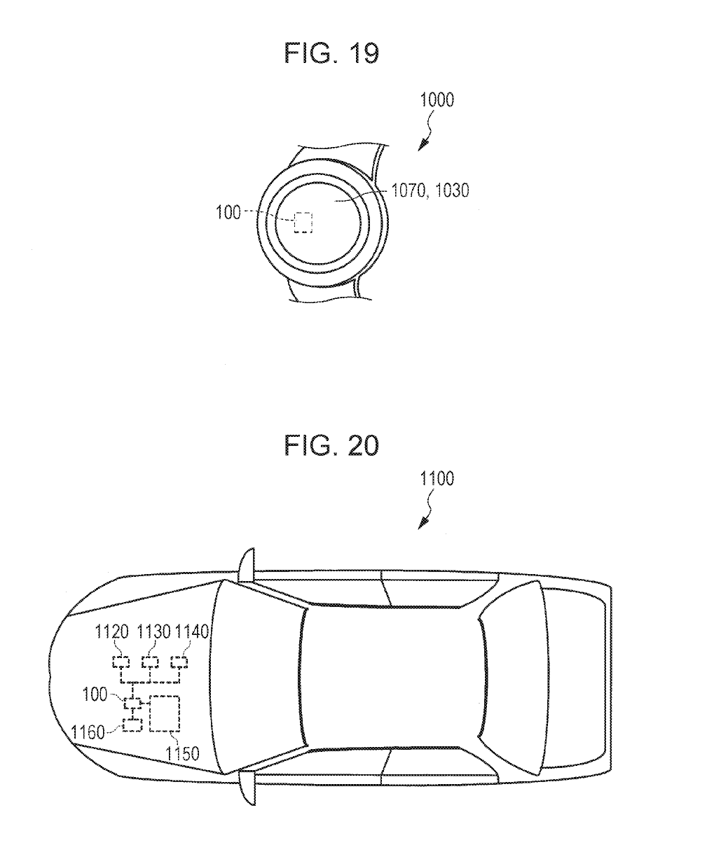

FIG. 19 is a diagram that illustrates an example of the appearance of a wristwatch-type wearable device, which is an example of the electronic equipment 1000. The wearable device 1000 is equipped with an LCD functioning as the display block 1070. A touch panel functioning as the operation block 1030 may be provided on the display block 1070.

The wearable device 1000 is further equipped with a location sensor such as a GPS (Global Positioning System) receiver, and can measure the movement distance and the movement path of the user.

5. Movable Body

Next, with reference to the accompanying drawing, a movable body according to an exemplary embodiment will now be explained. FIG. 20 is a schematic perspective view of an automobile that is an example of a movable body 1100 according to the present embodiment.

The movable body of the embodiment includes a physical quantity sensor according to some aspects of the invention In the description below, a case where the movable body includes the physical quantity sensor 100 is explained.

The movable body 1100 of the embodiment further includes controllers 1120, 1130, and 1140 that perform various kinds of control for an engine system, a brake system, and a keyless entry system, etc., a battery 1150, and a backup battery 1160. The movable body 1100 of the embodiment may be modified by omitting or changing a part of the constituent elements illustrated in FIG. 20, or by adding any other constituent element thereto.

Various movable objects are conceivable as the movable body 1100. Non-limiting examples are: an automobile (including an electric-powered vehicle), aircraft such as a jet plane or a helicopter, a ship, a rocket, or an artificial satellite.

Though exemplary embodiments are described above, the scope of the invention is not limited thereto. The invention can be modified in various ways within a range not departing from the gist thereof.

The invention encompasses every structure that is substantially the same as the structure described in the embodiments (for example, structure with the same function, method, and result, or structure with the same object and effect). The invention encompasses every structure that is obtained by replacement of a non-essential part in the structure described in the embodiments. The invention encompasses every structure that produces the same operational effect as that of the structure described in the embodiments, or structure that achieves the same object as that of the structure described in the embodiments. The invention encompasses every structure that is obtained by addition of known art to the structure described in the embodiments.

The entire disclosure of Japanese Patent Application No. 2015-042169, filed Mar. 4, 2015 is expressly incorporated by reference herein.

What is claimed is:

1. A physical quantity sensor, comprising:
a base;
a cover;
a function element provided inside a cavity formed by the base and the cover; and
a protection film with which a principal surface of the base, a bonding boundary portion between the principal surface of the base and the cover, and the cover are coated continuously,
wherein the protection film is an inorganic material film or an organic semiconductor film.

2. The physical quantity sensor according to claim 1,
wherein the base has a wiring groove that is in communication with the cavity;
wherein a wiring line is formed in the wiring groove; and
wherein the wiring groove and the wiring line are covered by the protection film.

3. The physical quantity sensor according to claim 2,
wherein the base has a pad; and
wherein the wiring line and the pad are electrically connected to each other.

4. A method for manufacturing a physical quantity sensor that includes a function element provided inside a cavity formed by a base and a cover, comprising:
bonding the base and the cover to each other to house the function element inside the cavity; and
forming a protection film with which a principal surface of the base, a bonding boundary portion between the principal surface of the base and the cover, and the cover are coated continuously,
wherein the protection film is an inorganic material film or an organic semiconductor film.

5. The method for manufacturing the physical quantity sensor according to claim 4, further comprising:
forming a wiring line in a wiring groove that is in communication with the cavity;
wherein, when the protection film is formed, the wiring groove and the wiring line get covered by the protection film.

6. The method for manufacturing the physical quantity sensor according to claim 4, further comprising:
partial cover removal,
wherein the base has a pad;
wherein the pad gets covered by the cover when the function element gets housed; and,
wherein a pad-covering part of the cover, by which the pad is covered, is removed after the forming of the protection film.

7. The method for manufacturing the physical quantity sensor according to claim 5, further comprising:
partial cover removal,
wherein the base has a pad;
wherein the pad gets covered by the cover when the function element gets housed; and,
wherein a pad-covering part of the cover, by which the pad is covered, is removed after the forming of the protection film.

8. Electronic equipment that includes the physical quantity sensor according to claim 1.

9. Electronic equipment that includes the physical quantity sensor according to claim 2.

10. Electronic equipment that includes the physical quantity sensor according to claim 3.

11. A movable body that includes the physical quantity sensor according to claim 1.

12. A movable body that includes the physical quantity sensor according to claim 2.

13. A movable body that includes the physical quantity sensor according to claim 3.
